(19) United States
(12) Patent Application Publication
(10) Pub. No.: US 2018/0186387 A1
(43) Pub. Date: Jul. 5, 2018

(54) Hopper Car with Low-Height Gate

(71) Applicant: Trinity North American Freight Car, Inc., Dallas, TX (US)

(72) Inventor: Shaun Richmond, Frankfort, IL (US)

(21) Appl. No.: 15/399,072

(22) Filed: Jan. 5, 2017

(51) Int. Cl. B61D 7/02; E05F 15/00

(52) U.S. Cl. CPC B61D 7/02; E05F 15/00; E05Y 2900/51; E05Y 2201/722; E05Y 2201/716

(57) ABSTRACT

According to some embodiments, a railcar with a pair of sidewall assemblies and a hopper comprises a plurality of transverse discharge openings. The railcar comprises a sliding gate assembly coupled to the hopper to control the discharge flow of lading. The sliding gate assembly comprises a support frame coupled to the hopper proximate the transverse discharge openings. The support frame extends longitudinally along the sidewall assemblies. The sliding gate assembly further comprises a plurality of discharge gates slidably coupled to the support frame; and a gate actuator operable to slide the plurality of discharge gates between a closed position, where each discharge gate is disposed adjacent to each of the discharge openings to restrict the discharge flow of lading, and an open position, where each discharge gate is disposed between discharge openings to permit the discharge flow of lading.

### TECHNICAL FIELD OF THE INVENTION

This disclosure generally relates to railcars, and more particularly to a hopper car with multiple low-height discharge gates.

### BACKGROUND

Railway hopper cars transport and sometimes store bulk materials. Hopper cars generally include one or more hoppers which may hold cargo or lading during shipment. Hopper cars are frequently used to transport coal, sand, metal ores, aggregates, grain, plastic pellets, and any other type of lading which may be satisfactorily discharged through openings formed in one or more hoppers. Discharge openings are typically provided at or near the bottom of each hopper to rapidly discharge cargo. A variety of door assemblies or gate assemblies along with various operating mechanisms have been used to open and close discharge openings associated with railway hopper cars.

For example, transversely oriented discharge openings and gates are frequently coupled with a linkage operated by an air cylinder. The air cylinder is typically mounted in the same orientation as the operating gate linkage which is often a longitudinal direction relative to the associated hopper.

Longitudinally oriented discharge openings and doors are often used in pairs that may be rotated or pivoted relative to the center sill or side sills of a hopper car. Longitudinally oriented discharge openings and doors may be coupled with a beam operated by an air cylinder. The air cylinder is typically mounted in the same orientation as the operating beam which is often a longitudinal direction relative to the associated hopper. The operating beam may be coupled to the discharge doors by door struts that push (or pull) the gates open or pull (or push) them closed as the air cylinder moves the operating beam back and forth.

Hopper cars may be classified as open or closed. Hopper cars may have relatively short sidewalls and end walls or relatively tall or high sidewalls and end walls. The sidewalls and end walls of many hopper cars are often formed from steel or aluminum sheets and reinforced with a plurality of vertical side stakes or support posts. Some hopper cars include interior frame structures or braces to provide additional support for the sidewalls.

### SUMMARY OF THE INVENTION

Particular embodiments described herein include a railcar with multiple low-height discharge gates. According to some embodiments, a railcar has an underframe, a pair of sidewall assemblies and at least one hopper formed between the sidewall assemblies. The railcar comprises a plurality of discharge openings. The discharge openings extend transversely across the at least one hopper and are disposed sequentially along a longitudinal direction of the at least one hopper. The railcar comprises a sliding gate assembly coupled to the at least one hopper to control the discharge flow of lading from the at least one hopper. The sliding gate assembly comprises a support frame coupled to the at least one hopper proximate the plurality of discharge openings. The support frame extends longitudinally along the sidewall assemblies. The sliding gate assembly further comprises a plurality of discharge gates slidably coupled to the support frame and a plurality of brackets coupling each discharge gate of the plurality of discharge gates to an adjacent discharge gate. The plurality of discharge gates are operable to slide between a closed position where each discharge gate of the plurality of discharge gates is disposed adjacent to each of the plurality of discharge openings to restrict the discharge flow of lading from the at least one hopper, and an open position where each discharge gate of the plurality of discharge gates is disposed between discharge openings of the plurality of discharge openings to permit the discharge flow of lading from the at least one hopper.

In particular embodiments, the railcar further comprises a plurality of ridges, each ridge of the plurality of ridges is disposed between two adjacent discharge openings of the plurality of discharge openings and configured to guide a discharge flow of lading towards at least one of the two discharge openings. The railcar may further comprise a center sill extending longitudinally along the center of the railcar and the plurality of ridges are disposed below the center sill.

In particular embodiments, a longitudinal width of each discharge gate of the plurality of discharge gates and a longitudinal width of each ridge of the plurality of ridges at the widest portion of the ridge are configured so that a discharge gate of the plurality of discharge gates does not interfere with the discharge flow of lading from an adjacent discharge opening of the plurality of discharge openings when the plurality of discharge gates are in the open position. Each discharge gate of the plurality of discharge gates may comprise a gate width in the longitudinal direction, and each ridge of the plurality of ridges may comprise a ridge width at the widest portion of the ridge in the longitudinal direction. The gate width is approximately equal to the ridge width.

In particular embodiments, each gate of the plurality of gates is coupled to an adjacent gate of the plurality of gates, and the gate actuator is operable to slide each discharge gate of the plurality of discharge gates simultaneously. The gate actuator may comprise a rack and pinion. The pinion may be coupled to the support frame and at least one of the discharge gates may comprise the rack operably coupled to the pinion. In particular embodiments, the railcar further comprises two hoppers. The gate actuator is disposed between the two hoppers, and the gate actuator slides the plurality of discharge gates towards a center of the railcar to open the plurality of discharge gates.

In particular embodiments, the sliding gate assembly further comprises a low friction material disposed between a portion of the support frame and the plurality of discharge gates. The support frame may comprise a pair of support members coupled to the pair of sidewalls.

Some embodiments include a sliding gate assembly for a railcar. The railcar has an underframe, a pair of sidewall assemblies and at least one hopper formed between the sidewall assemblies. The sliding gate assembly comprises a support frame configured to extend longitudinally along the at least one hopper proximate a plurality of discharge openings. The discharge openings may extend transversely across the at least one hopper and may be disposed sequentially along a longitudinal direction of the at least one hopper. The sliding gate assembly further comprises a plurality of discharge gates slidably coupled to the support frame. The plurality of discharge gates are operable to slide between a closed position, where each discharge gate of the plurality of discharge gates is configured to be disposed adjacent to each of the plurality of discharge openings to restrict the discharge flow of lading from the at least one hopper, and an open position, where each discharge gate of the plurality of discharge gates is configured to be disposed between discharge openings of the plurality of discharge openings to permit the discharge flow of lading from the at least one hopper.

In particular embodiments, a longitudinal width of each discharge gate of the plurality of discharge gates and a longitudinal distance between each discharge gate of the plurality of discharge gates are configured so that a discharge gate of the plurality of discharge gates does not interfere with the discharge flow of lading from an adjacent discharge opening of the plurality of discharge openings when the plurality of discharge gates are in the open position. A width of each discharge gate of the plurality of discharge gates in the longitudinal direction may comprise a first value, and a distance between each discharge gate of the plurality of discharge gates may comprise a second value. The first value is approximately equal to the second value.

In particular embodiments, the sliding gate assembly further comprises a gate actuator operable to slide the plurality of discharge gates simultaneously. The gate actuator may comprise a rack and pinion. The pinion may be coupled to the support frame and at least one of the discharge gates may comprise the rack operably coupled to the pinion.

In particular embodiments, the sliding gate assembly further comprises a low friction material disposed between a portion of the support frame and the plurality of discharge gates.

According to some embodiments, a railcar has an underframe, a pair of sidewall assemblies and at least one hopper formed between the sidewall assemblies. The railcar comprises a plurality of discharge openings. The discharge openings may extend transversely across the at least one hopper and may be disposed sequentially along a longitudinal direction of the at least one hopper. The railcar further comprises a plurality of ridges. Each ridge of the plurality of ridges is disposed between two adjacent discharge openings of the plurality of discharge openings and may be configured to guide a discharge flow of lading towards at least one of the two discharge openings. The railcar further comprises a center sill extending longitudinally along the center of the railcar. The plurality of ridges are disposed below the center sill.

In particular embodiments, a width of each discharge opening of the plurality of discharge openings in the longitudinal direction comprises a first value, and a distance between each discharge opening of the plurality of discharge openings comprises a second value. The first value is approximately equal to the second value.

According to some embodiments, a railcar has an underframe, a pair of sidewall assemblies and at least one hopper formed between the sidewall assemblies. The railcar comprises a plurality of discharge openings. The discharge openings are proximate a bottom of the at least one hopper for discharging a lading from the at least one hopper. The railcar further comprises a plurality of ridges. Each ridge of the plurality of ridges is disposed between adjacent discharge openings of the plurality of discharge openings. The discharge openings may extend transversely across the at least one hopper.

In particular embodiments, a width of each discharge opening of the plurality of discharge openings comprises a first value, and a distance between each discharge opening of the plurality of discharge openings comprises a second value. The first value is approximately equal to the second value.

As a result, particular embodiments of the present disclosure may provide numerous technical advantages. For example, the low-height gates of particular embodiments may increase the available volume of a railcar or reduce the size of a railcar, which enables a carrier to carry more lading, or to carry the same lading with a smaller railcar. The low-height gates lower the center of gravity of the railcar, which may enable the railcar to safely carry additional lading compared to a conventional hopper car.

Particular embodiments are advantageous over railcars with longitudinal discharge doors. For example, railcars with longitudinal discharge doors typically require a center sill, and not all railcars have a center sill. Embodiments of the low-height discharge gates described herein may be outfitted on railcars that do not have a center sill.

As another advantage, particular embodiments that include a railcar with a center sill and a low-height gate mechanism are simpler and less costly to manufacture than a conventional hopper with full-height ridges between discharge gates. For example, the full-height ridges extend above the center sill and the center sill passes through the ridges, which complicates construction of the railcar. Full-height gates may also complicate structural connections between the sidewalls of the railcar. The low-height gates of particular embodiments do not extend above the center sill. The center sill does not pass through the ridges between low-height gates, simplifying construction of the railcar. Also, low-height gates are less restrictive than full-height ridges when making structural connections between the sidewalls of the railcar. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 is a schematic drawing illustrating a side view of an example hopper car;

FIG. 2 is a schematic drawing illustrating a side view of the ridges and center sill of an example hopper car;

FIG. 3 is a schematic drawing illustrating a cross-sectional side view of a hopper car with low-height gates, according to a particular embodiment;

FIG. 4A is a schematic drawing illustrating a cross-sectional side view of a portion of a low-height gate in a closed position, according to a particular embodiment;

FIG. 4B is a schematic drawing illustrating a cross-sectional side view of a portion of a low-height gate in an open position, according to a particular embodiment;

FIG. 5 is a schematic drawing illustrating a cross-sectional end view of a portion of a low-height gate, according to a particular embodiment;

FIG. 6 is a perspective schematic drawing illustrating an example sliding gate assembly, according to a particular embodiment; and

FIG. 7 is a schematic drawing illustrating a cross-sectional side view of a portion of a low-height gate with a rack and pinion, according to a particular embodiment.

### DETAILED DESCRIPTION

Railway hopper cars generally include one or more hoppers which may hold cargo or lading (e.g., bulk materials) during shipment. Hopper cars frequently transport coal, sand, metal ores, aggregates, grain, plastic pellets, and any other type of lading which may be satisfactorily discharged through openings formed in one or more hoppers. Discharge openings are typically provided at or near the bottom of each hopper to rapidly discharge cargo. A variety of door assemblies or gate assemblies along with various operating mechanisms have been used to open and close discharge openings associated with railway hopper cars.

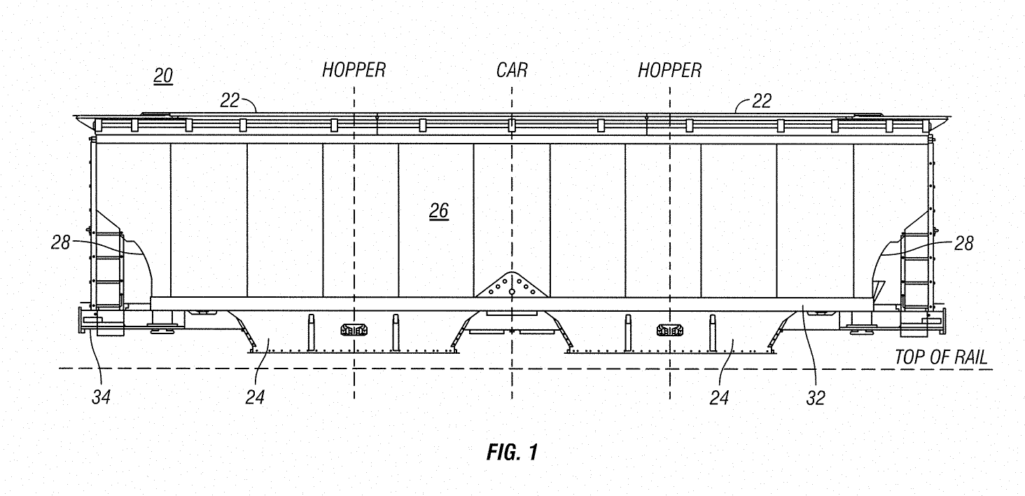

FIG. 1 is a schematic drawing illustrating a side view of an example hopper car. Hopper car 20 may carry bulk materials such as coal and other types of lading. Examples of such lading may include sand, metal ores, aggregate, grain, ballast, etc.

Hopper car 20 may be generally described as a covered hopper car. However, other embodiments may include open hopper cars or any other cars (e.g., gondola cars) suitable for carrying bulk lading. Hopper car 20 includes containers for transporting its lading, such as hoppers 22 with bottom discharge assemblies 24. Discharge assemblies 24 may be opened and closed to control discharge of lading from hoppers 22. As illustrated, hopper car 20 includes two hoppers 22. Particular embodiments of hopper car 20 may include one, two, three, or any suitable number of hoppers 22. Particular embodiments may include other containers for transporting lading, with or without discharge assemblies.

In particular embodiments, hopper 22 is configured to carry bulk materials and the interior walls of hopper 22 are generally sloped towards discharge assembly 24 to facilitate discharge of the lading. Multiple hoppers 22 may be separated by interior bulkheads.

In particular embodiments, hopper car 20 may include a pair of sidewall assemblies 26 and sloped end wall assemblies 28 mounted on a railway car underframe. The railway car underframe includes center sill 34 and a pair of sill plates 32. The pair of sill plates 32 provide support for sidewall assemblies 26.

Center sill 34 is a structural element for carrying the loads of the hopper car. Center sill 34 transfers the various longitudinal forces encountered during train operation from car to car.

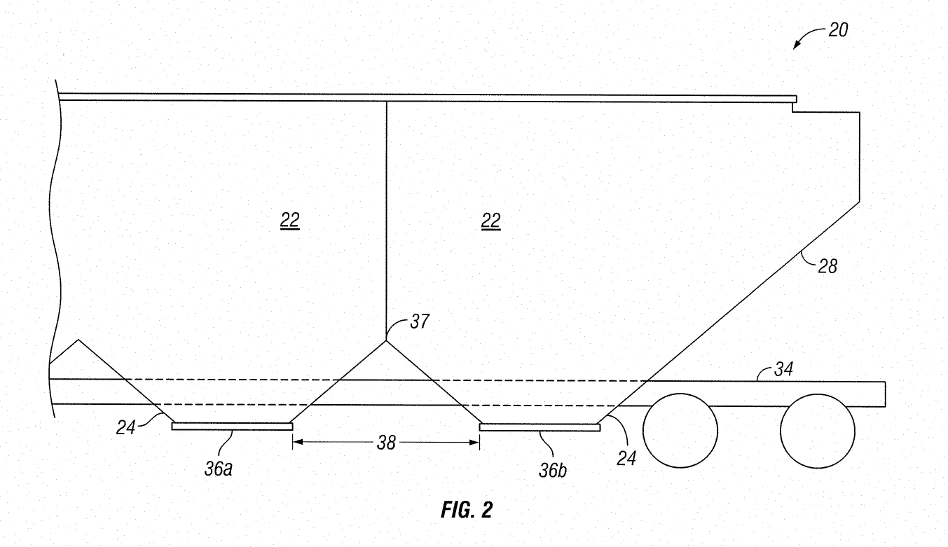

Conventional hopper cars may typically have 2, 3 or 4 hoppers with a single sliding gate below the discharge opening of each hopper. The sloping interior walls of hopper 22 create a ridge between the discharge openings to guide the lading towards the discharge opening. The sloping walls may also be referred to as gate supports. Conventional hopper cars typically have tall ridges between hoppers 22. An example of a ridge is illustrated in FIG. 2.

FIG. 2 is a schematic drawing illustrating a side view of the ridges and center sill of an example hopper car. Hopper car 20 is similar to hopper car 20 described with respect to FIG. 1. Hopper car 20 includes two hoppers 22 with discharge assemblies 24. Transverse discharge gates 36 are operable to slide in the longitudinal direction of hopper car 20 to discharge the lading of hoppers 22 through the discharge openings of discharge assemblies 24.

The sloping interior walls of hopper 22 form ridge 37. Ridge 37 comprises two sloping edges between adjacent discharge gates 36a and 36b. Distance 38 is the distance between adjacent discharge gates 36a and 36b. Ridge 37 is widest at its bottom-most portion (i.e., distance 38). The two sloping edges extend upward where they join together, forming ridge 37. Ridge 37 may be referred to as a full-height ridge.

The particular width of discharge gates 26, and the particular width and height of ridges 37 depend on the length and height of railcar 20 and each hopper 22. In some conventional hopper cars, gates 26 may be four or five feet wide and ridges 37 may be four feet high, as one example.

A particular goal of rail operators is to increase the available volume in a railcar so that the railcar may carry more lading, or carry the same lading in a shorter car. One way to increase the available railcar volume is to remove the ridges. For example, hopper cars with longitudinal discharge doors do not require ridges.

Longitudinal doors are typically supported by the center sill and use a linkage mechanism to swing open. A disadvantage of a longitudinal door, however, is that the longitudinal door requires a center sill. Some railcars do not have a center sill, which prevents the railcars from using a longitudinal door. The center sill and longitudinal door may also complicate structural connections between the sides of the railcar.

Another disadvantage of tall (or full-height) ridges is that the tall ridge complicates the construction of the railcar. As illustrated in FIG. 2, the height of ridge 37 extends above center sill 34. Center sill 34 extends through the interior of a first hopper 22, passes through a wall of the first hopper 22, extends through ridge 37 between hoppers 22, and passes through a wall of a second hopper 22. The various intersections between center sill 34 and the walls of hopper 22 complicate construction of railcar 20.

Particular embodiments obviate the problems described above and include a railcar, such as a hopper car, with multiple low-height discharge gates. Using a plurality of small discharge gates, relative to a single large discharge gate of a conventional hopper, results in a plurality of small ridges. A low-height discharge gate may refer to a combination of a small discharge gate and small ridge.

A particular advantage of low-height gates is increased available volume of the railcar (or a reduced size railcar with the original volume). The low-height gates lower the center of gravity of the railcar, which may enable the railcar to safely carry additional lading compared to a conventional hopper car.

Particular embodiments are advantageous over railcars with longitudinal discharge doors. As one example, embodiments of the low-height discharge gates described herein may be outfitted on railcars that do not have a center sill.

As another example, a railcar that does have a center sill is simpler and less costly to manufacture when using a low-height gate mechanism compared to a conventional hopper with full-height ridges between discharge gates. The low-height gates of particular embodiments do not extend above the center sill. The center sill does not pass through the ridges between low-height gates, simplifying construction of the railcar. Also, low-height gates are less restrictive than full-height ridges when making structural connections between the sidewalls of the railcar.

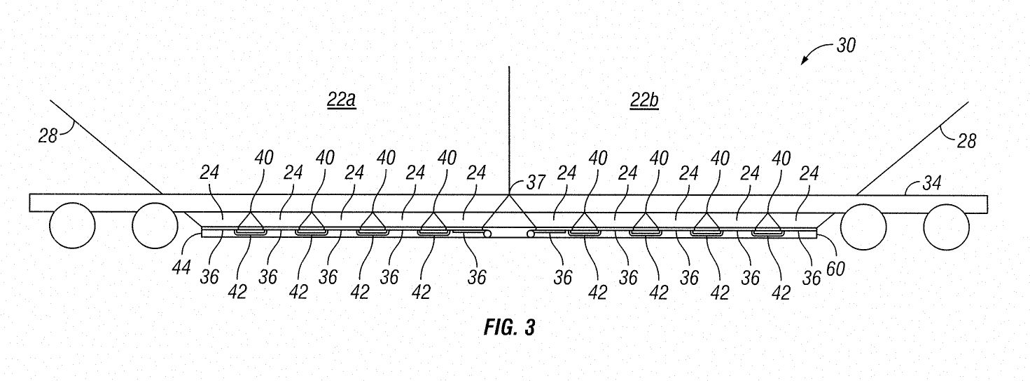

Particular embodiments of the invention and its advantages are best understood by reference to FIGS. 3 through 7, wherein like reference numbers indicate like features.

FIG. 3 is a schematic drawing illustrating a cross-sectional side view of a hopper car with low-height gates, according to a particular embodiment. Railcar 30 comprises a hopper car with two hoppers 22. Railcar 30 has an underframe, including center sill 34, and a pair of sidewall assemblies similar to railcar 20 illustrated in FIG. 1. The pair of sidewall assemblies form hoppers 22.

Railcar 30 comprises a plurality of discharge assemblies 24. Each discharge assembly 24 includes a discharge opening to enable a discharge flow of lading from hopper 22. Each discharge opening extends transversely across hopper 22 (i.e., across the width of railcar 30). The plurality of discharge openings extend sequentially along the longitudinal direction of railcar 30 (and thus along a longitudinal direction of hoppers 22 as well).

Discharge assemblies 24 include sloping walls to guide the lading towards the discharge opening. The sloping walls of adjacent discharge assemblies 24 form ridges 40. Ridge 40 may be referred to as a low-height ridge. In particular embodiments, ridges 40 may range from approximately one to two feet high.

Each ridge 40 is disposed between two discharge openings of adjacent discharge assemblies 24. In particular embodiments, the walls of ridge 40 may slope at approximately forty-five degrees. In some embodiments, the walls of ridge 40 may slope at any suitable angle based on the particular lading of hopper 22.

Although the illustrated embodiment includes two hoppers 22, each hopper 22 including five discharge assemblies 24, other embodiments may include any suitable number of hoppers 22 and discharge assemblies 24.

The sloping walls at the partition between hopper 22a and hopper 22b form ridge 37. In the illustrated embodiment, ridge 37 comprises a full-height ridge. In other embodiments, ridge 37 may comprise a low-height ridge, such as ridge 40.

In particular embodiments, railcar 30 comprises sliding gate assembly 60. Sliding gate assembly 60 may be coupled to one or more of hoppers 22. Sliding gate assembly 60 is operable to control a discharge flow of lading from one or more of hoppers 22. A discharge flow of lading refers to the lading of hopper 22 as it is discharged through a discharge opening (e.g., the coal, grain, sand, etc., as it is flowing through the discharge opening to exit the hopper).

Particular embodiments may include one sliding gate assembly 60 that controls a discharge flow for one or more hoppers 22. The illustrated embodiment includes one sliding gate assembly 60 that controls a discharge flow for two hoppers 22. In some embodiments, portions of sliding gate assembly 60 may be operated independently to individually control a discharge flow for one or more hoppers 22 (e.g., individually control hopper 22a and hopper 22b). Some embodiments of railcar 30 may include multiple sliding gate assemblies 60 (e.g., one sliding gate assembly 60 per hopper 22).

Sliding gate assembly 60 comprises support frame 44 and a plurality of discharge gates 36. Support frame 44 may be coupled to one or more hoppers 22 proximate the plurality of discharge openings of discharge assemblies 24. Support frame 44 provides support for plurality of discharge gates 36. In the illustrated embodiment, support frame 44 extends the length of railcar 30 (i.e., from side sheet to side sheet). In other embodiments, support frame 44 may extend the length of a hopper 22. Railcar 30 may include multiple support frames 44.

Discharge gates 36 are slidably coupled to support frame 44. Discharge gates 36 are operable to slide between a closed position and an open position. In the closed position, each discharge gate 36 is disposed adjacent to each of the discharge openings of discharge assemblies 24 to restrict the discharge flow of lading from hopper 22 (e.g., discharge gate 36 is directly underneath discharge assembly 24 and held tight against discharge assembly 24 to prevent lading from exiting hopper 22). In the open position, each discharge gate 36 is disposed between discharge openings of discharge assemblies 24 to permit the discharge flow of lading from hopper 22 (e.g., discharge gate 36 is underneath ridge 40 (or 37) permitting flow of lading out of hopper 22).

Sliding gate apparatus 60 may be referred to as in the open position when discharge gates 36 are in the open position. Sliding gate apparatus 60 may be referred to as in the closed position when discharge gates 36 are in the closed position.

Discharge gate 36 may comprise a metal plate. In some embodiments, discharge gate 36 may comprise any other suitable material according the particular lading of hopper 22.

In particular embodiments, support frame 44 comprises a ledge, groove, or other suitable support for discharge gates 36. Although a particular support frame 44 is illustrated, other embodiments may include any suitable frame for supporting discharge gates 36.

In particular embodiments, sliding gate assembly 60 comprises brackets 42. Bracket 42 couples discharge gate 36 to an adjacent discharge gate 36. In particular embodiments, brackets 42 are disposed proximate an edge of sliding gate 36 and proximate support frame 44 so that brackets 42 do not interfere with the discharge of lading when sliding gate assembly 60 is in the open position. Brackets 42 may comprise metal brackets or any other suitable material for coupling adjacent discharge gates 36.

In the illustrated embodiment, a first plurality of brackets 42 couple the discharge gates 36 under hopper 22a to each other, and a second plurality of brackets 42 couple the discharge gates 36 under hopper 22b to each other. Discharge gates 36 under hopper 22a may be operated simultaneously (e.g., the five discharge gates 36 coupled together with brackets 42 may be opened at the same time, or closed at the same time). Similarly, discharge gates 36 under hopper 22b may be operated simultaneously. In particular embodiments, discharge gates 36 under hopper 22a may be operated independently from discharge gates 36 under hopper 22b. In some embodiments, discharge gates 36 under hopper 22a and discharge gates 36 under hopper 22b may be operated simultaneously.

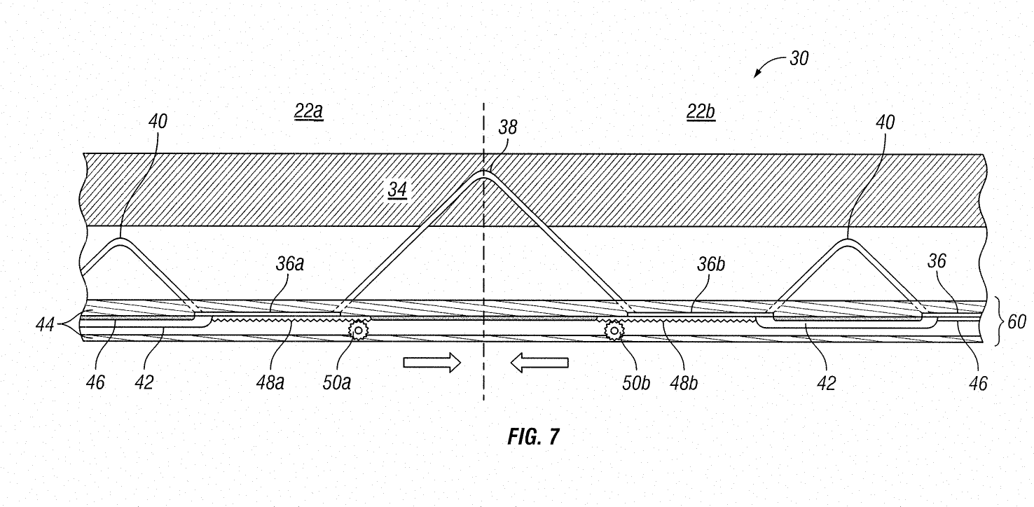

In particular embodiments, sliding gate assembly 60 includes a gate actuator operable to slide a plurality of discharge gates 36 from a closed position to an open position, and vice versa. The gate actuator may comprise a rack and pinion, piston, mechanical linkage, etc., and may be operated manually, electrically, pneumatically, hydraulically, etc. In particular embodiments, sliding gate assembly 60 may include multiple gate actuators (e.g., one per hopper 22). An example gate actuator is described in more detail with respect to FIG. 7.

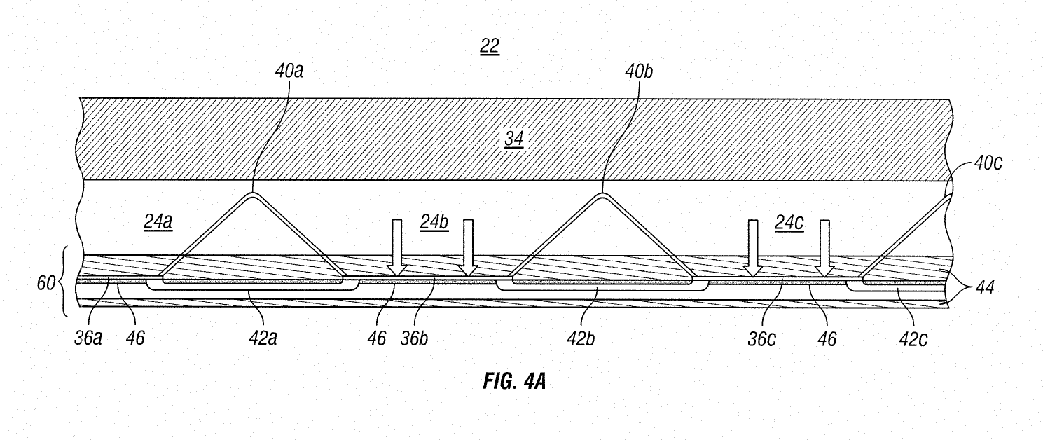

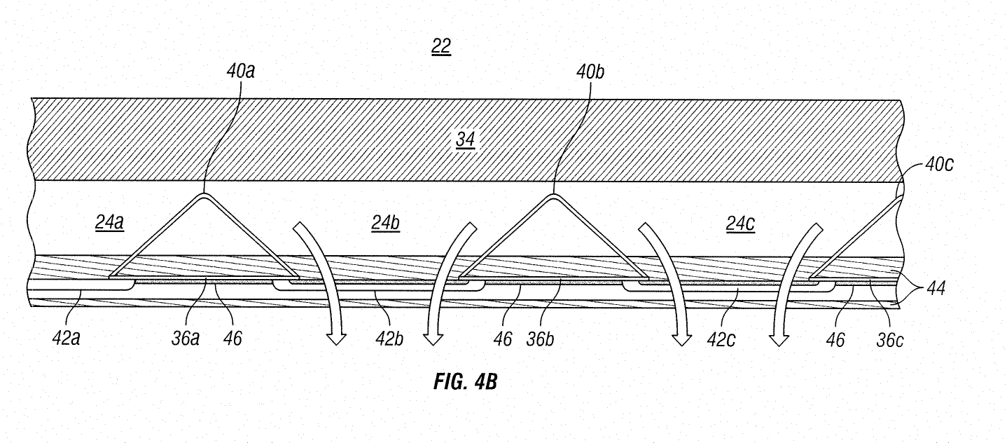

FIG. 4A is a schematic drawing illustrating a cross-sectional side view of a portion of a low-height gate in a closed position, according to a particular embodiment. Hopper 22, discharge assemblies 24, center sill 34, ridges 40, and sliding gate assembly 60 are similar to those described with respect to FIG. 3.

Each discharge gate 36 is disposed adjacent to each of the discharge openings of discharge assemblies 24 to restrict (illustrated by arrows) the discharge flow of lading from hopper 22. For example, discharge gate 36a is underneath discharge assembly 24a and held tight against discharge assembly 24a to prevent lading from exiting hopper 22. Similarly, discharge gates 36b and 36c are underneath discharge assemblies 24b and 24c, respectively.

In particular embodiments, sliding gate assembly 60 includes low-friction material 46. Low-friction material 46 is disposed between support frame 44 and discharge gates 36. Low-friction material 46 facilitates discharge gate 36 sliding on support frame 44. Low-friction material 46 may comprise plastic, polymer, rollers, bearings, or any other suitable material for reducing friction between discharge gates 36 and support frame 44.

FIG. 4B is a schematic drawing illustrating a cross-sectional side view of a portion of a low-height gate in an open position, according to a particular embodiment. Hopper 22, discharge assemblies 24, center sill 34, ridges 40, and sliding gate assembly 60 are similar to those described with respect to FIG. 4A.

Each discharge gate 36 is disposed between discharge openings of discharge assemblies 24 to permit the discharge flow of lading (illustrated by arrows) from hopper 22. For example, discharge gate 36a is underneath ridge 40a permitting flow of lading out of hopper 22 via discharge assembly 24a. Bracket 42a is underneath the discharge opening of discharge assembly 24a, but as described above bracket 42a is disposed not to interfere (or minimize interference) with the discharge of lading. Similarly, discharge gates 36b and 36c are underneath ridges 40b and 40c, respectively.

As illustrated in FIGS. 4A and 4B, each ridge 40 is disposed between two discharge openings of adjacent discharge assemblies 24. For example ridge 40a is disposed between adjacent discharge assemblies 24a and 24b, and ridge 40b is disposed between adjacent discharge assemblies 24b and 24c. Ridge 40a guides a discharge flow of lading towards at least one of discharge assemblies 24a and 24b. Similarly, ridge 40b guides a discharge flow of lading towards at least one of discharge assemblies 24b and 24c.

In particular embodiments, a longitudinal width (i.e., width from left to right in the illustrated example) of each discharge gate 36 and a longitudinal width (i.e., width from left to right in the illustrated example) of each ridge 40 at the widest portion of ridge 40 (e.g., equivalent to distance 38 of ridge 37 in FIG. 1) are configured so that a discharge gate (e.g., discharge gate 36a) does not interfere with the discharge flow of lading from an adjacent discharge opening (e.g., discharge opening of discharge assemblies 24a or 24b) when sliding gate apparatus 60 is in the open position.

In particular embodiments, discharge gates 36 are of equal width to each other, ridges 40 are of equal width to each other, and the widths of discharge gates 36 are equal to the widths of ridges 40. For example, discharge gates 36a, 36b and 36c and ridges 40a, 40b and 40c are all approximately the same width. While discharge gates 36 and ridges 40 may not be exactly the same width to account for particular tolerances, support structures, etc., an advantage of discharge gates 36 and ridges 40 being approximately the same width optimizes the width of the discharge openings of discharge assembly 24, which optimizes the rate at which lading may be discharged from hoppers 22. For example, if discharge gate 36a is significantly wider than ridge 40a, then when in the open position discharge gate 36 may interfere with the lading discharged from discharge assemblies 24a or 24b. If discharge gate 36a is significantly less than the width of ridge 40a, then the discharge rate may be suboptimal because the discharge openings are not as wide as they could be.

In the illustrated embodiments, the ridges 40 are disposed below center sill 34. The distance from the discharge opening to the top of ridge 40 is less than the distance from the discharge opening to the bottom of center sill 34. A particular advantage of low-height gates is that center sill 34 does not pass through ridges 40, simplifying construction of railcar 30. Also, low-height gates are less restrictive than full-height ridges when making structural connections between the sidewalls of railcar 30.

The particular width of discharge gates 36 and ridges 40 may depend on the length and height of railcar 30, the length and height of hoppers 22, and/or the height of center sill 34 above the discharge openings. For particular embodiments, the height of center sill 34 above the discharge openings may determine a maximum ridge height. The particular lading of hopper 22 may determine a particular angle or range of angles for the walls of ridge 40. For example, coarser lading may require larger discharge gates.

The maximum ridge height and the angle of the walls of ridge 40 may be used to determine a maximum ridge/gate width. The maximum ridge/gate width may be adjusted up or down based on the length of car 30 or hoppers 22 so that the total length of the car or hopper is divided into approximately equal width discharge gates 36 and ridges 40 that are close to but do not exceed the maximum ridge/gate width. Other embodiments may include more or less criteria when determining a ridge/gate width.

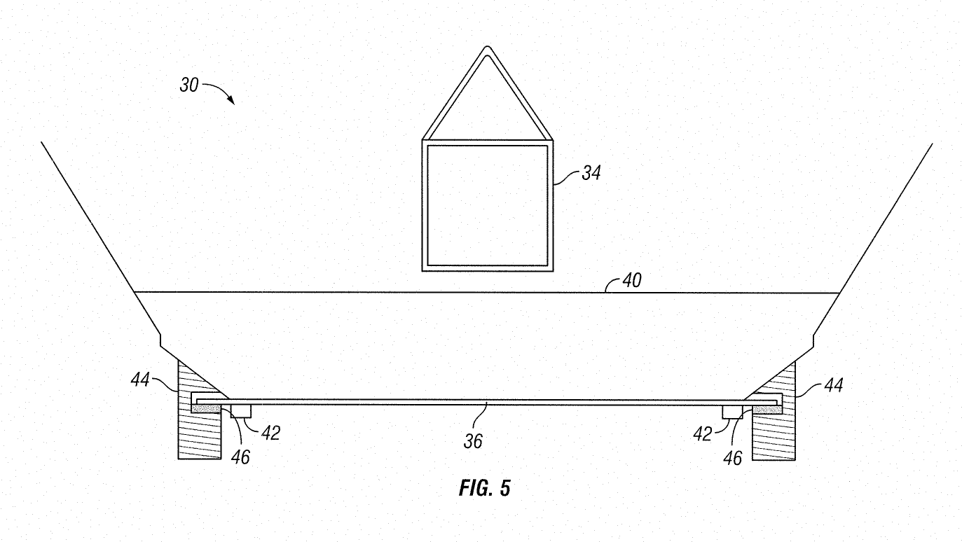

FIG. 5 is a schematic drawing illustrating a cross-sectional end view of a portion of a low-height gate, according to a particular embodiment. FIG. 5 illustrates a cross sectional view of railcar 30 described with respect to FIGS. 3-4B.

In particular embodiments, ridge 40 is disposed below center sill 34. Support frame 44 comprises a pair of support members coupled to the sidewalls of railcar 30. Support frame 44 is coupled to railcar 30 proximate the discharge openings. Support frame 44 supports discharge gate 36, which extends transversely across the width of railcar 30.

Discharge gate 36 is supported by a groove in support member 44. In some embodiments, discharge gate 36 may be supported by a ledge or any other suitable support. In particular embodiments, discharge gate 36 slides on low-friction material 46. Discharge gate 36 may be referred to as slidably coupled to support frame 44.

Brackets 42 couple adjacent discharge gates 36. In the illustrated embodiment, brackets 42 are coupled to discharge gates 36 just outside of support frame 44 towards the center of railcar 30. In other embodiments, brackets 42 may be disposed within support frame 44 in a groove or other suitable opening.

Although FIGS. 3-5 illustrate railcars that include a center sill, particular embodiments do not include a center sill. A particular advantage of low-height transverse gates is that they may be employed on railcars without a center sill Thus, the same benefits of a center sill railcar without ridges (e.g., hopper car with longitudinal discharge doors) may be realized by a railcar with transverse sliding gates, which many operators prefer over longitudinal gates.

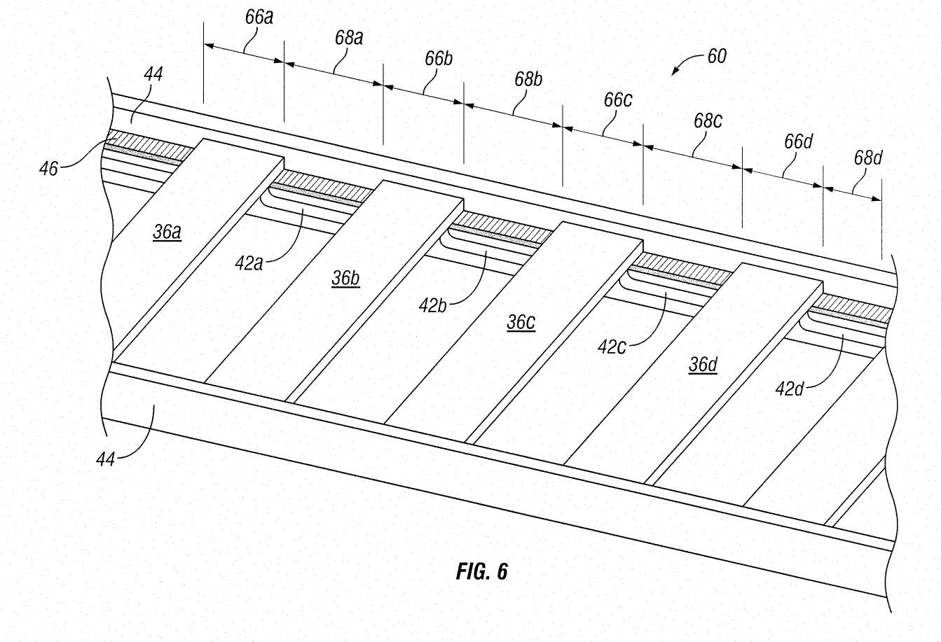

FIG. 6 is a perspective schematic drawing illustrating an example sliding gate assembly, according to a particular embodiment. FIG. 6 illustrates a perspective view of sliding gate assembly 60 described with respect to FIGS. 3-4B.

Sliding gate assembly 60 comprises support frame 44 and a plurality of discharge gates 36 slidably coupled to support frame 44. Support frame 44 is configured to be coupled to railcar 30.

In particular embodiments, discharge gates 36 may slide on low-friction material 46.

Brackets 42 couple adjacent discharge gates 36. For example, bracket 42a couples discharge gates 36a and 36b. Bracket 42b couples discharge gates 36b and 36c, etc. When coupled to railcar 30, discharge gates 36 are operable to slide between the closed and open positions as described above.

Each discharge gate 36 comprises a longitudinal width 66. In this example, longitudinal width is referring to a longitudinal axis of railcar 30 when sliding gate assembly is coupled to railcar 30. Discharge gates 36 are separated by longitudinal distance 68. In particular embodiments, each longitudinal width 66 is approximately the same width (i.e., 66a =66b =66c =66d). In particular embodiments, each longitudinal distance 68 is the same distance (i.e., 68a =68b =68c =68d). In some embodiments, each longitudinal width 66 and each longitudinal distance 68 are approximately the same (i.e., 66a=68a=66b=68b=66c=68c=66d=68d). Advantages of discharge gates separated by approximately the same distance as the width of the discharge gate are described above with respect to FIGS. 4A and 4B.

In particular embodiments, sliding gate apparatus 60 comprises a gate actuator. An example is illustrated in FIG. 7.

FIG. 7 is a schematic drawing illustrating a cross-sectional side view of a portion of a low-height gate with a rack and pinion, according to a particular embodiment. In particular embodiments, sliding gate assembly 60 includes a gate actuator operable to slide plurality of discharge gates 36 from a closed position to an open position, and vice versa. The gate actuator may comprise rack 48 and pinion 50.

In particular embodiments, rack 48 is coupled to discharge gate 36. Pinion 50 is coupled to support frame 44. Pinion 50 and rack 48 are coupled to each other via rack and pinion gears. In operation, pinion 50 rotates causing rack 48 to move horizontally. Rack 48 is coupled to discharge gate 36, so discharge gate 36 also moves horizontally. Discharge gate 36 may be coupled to one more discharge gates 36 via brackets 42, in which case all the coupled discharge gates 36 move horizontally.

In the illustrated embodiment, pinions 50a and 50b are disposed between hoppers 22a and 22b near the center of railcar 30. Pinion 50a is operable to slide discharge gate 36a towards the center of railcar 30, and pinion 50b is operable to slide discharge gate 36b towards the center of railcar 30 (arrows in illustration). In particular embodiments, each pinion may be operated independently, which means each hopper 22 may be discharged independently.

In the illustrated embodiment, ridge 38 between hoppers 22a and 22b is wider than ridges 40. Ridge 38 may be twice as wide as ridges 40, enabling both discharge gate 36a and 36b to slide under ridge 38 in the open position.

In other embodiments, rack 48 and pinion 50 may be disposed at any suitable location along the length support frame 44. In particular embodiments rack 48 and pinion 50 may be disposed proximate an end of railcar 30 and operable to slide discharge gates 36 horizontally towards the end of railcar 30. In these embodiments care is taken that discharge gates 36, in the open position, do not interfere with the trucks of railcar 30.

In other embodiments, the gate actuator may comprise a piston, mechanical linkage, or any other suitable actuator. The gate actuator may be operated manually, electrically, pneumatically, hydraulically, etc.

Although particular embodiments described herein include sliding gates, other embodiments may include any suitable type of gate operation. For example, in some embodiments a railcar may include multiple discharge openings and low ridges, and hinged-gates (e.g. one gate hinged on one side of a discharge opening, two gates hinged on each side of a discharge opening, etc.) may control discharge from the discharge openings.

Particular embodiments include ridges illustrated with an inverted “V” configuration and generally horizontal discharge openings between the ridges. Other embodiments may include any suitable ridge configuration. For example, in some embodiments a railcar may include multiple discharge openings and low ridges where the ridges form an inverted “V” without generally horizontal discharge opening between the ridges. The discharge opening may comprise one leg of the “V.” The discharge opening may include a hinged door to control lading discharge.

Some embodiments of the disclosure may provide one or more technical advantages. For example, the low-height gates of particular embodiments may increase the available volume of a railcar or reduce the size of a railcar, which enables a carrier to carry more lading, or to carry the same lading with a smaller railcar. The low-height gates lower the center of gravity of the railcar, which may enable the railcar to safely carry additional lading compared to a conventional hopper car.

Particular embodiments are advantageous over railcars with longitudinal discharge doors. For example, railcars with longitudinal discharge doors typically require a center sill, and not all railcars have a center sill. Embodiments of the low-height discharge gates described herein may be outfitted on railcars that do not have a center sill. Some operators prefer transverse slide gates over longitudinal doors.

As another advantage, particular embodiments that include a railcar with a center sill and a low-height gate mechanism are simpler and less costly to manufacture than a conventional hopper with full-height ridges between discharge gates. The low-height gates of particular embodiments do not extend above the center sill. The center sill does not pass through the ridges between low-height gates, simplifying construction of the railcar. Also, low-height gates are less restrictive than full-height ridges when making structural connections between the sidewalls of the railcar. Other technical advantages may be readily ascertained by one of ordinary skill in the art.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components.

Although embodiments of the present disclosure and their advantages have been described in detail, it should be understood that various changes, substitutions and alternations can be made herein without departing from the spirit and scope of the invention as defined by the claims below.

1. A railcar having an underframe, a pair of sidewall assemblies and at least one hopper formed between the sidewall assemblies, the railcar comprising:
a plurality of discharge openings, the discharge openings extending transversely across the at least one hopper and disposed sequentially along a longitudinal direction of the at least one hopper;
a sliding gate assembly coupled to the at least one hopper to control the discharge flow of lading from the at least one hopper, the sliding gate assembly comprising:
a support frame coupled to the at least one hopper proximate the plurality of discharge openings, the support frame extending longitudinally along the sidewall assemblies;
a plurality of discharge gates slidably coupled to the support frame; and
a gate actuator operable to slide the plurality of discharge gates between a closed position where each discharge gate of the plurality of discharge gates is disposed adjacent to each of the plurality of discharge openings to restrict the discharge flow of lading from the at least one hopper, and an open position where each discharge gate of the plurality of discharge gates is disposed between discharge openings of the plurality of discharge openings to penult the discharge flow of lading from the at least one hopper.

2. The railcar of claim 1, further comprising a plurality of ridges, each ridge of the plurality of ridges disposed between two adjacent discharge openings of the plurality of discharge openings and configured to guide a discharge flow of lading towards at least one of the two discharge openings.

3. The railcar of claim 2, further comprising a center sill extending longitudinally along the center of the railcar, and wherein the plurality of ridges are disposed below the center sill.

4. The railcar of claim 2, wherein a longitudinal width of each discharge gate of the plurality of discharge gates and a longitudinal width of each ridge of the plurality of ridges at the widest portion of the ridge are configured so that a discharge gate of the plurality of discharge gates does not interfere with the discharge flow of lading from an adjacent discharge opening of the plurality of discharge openings when the plurality of discharge gates are in the open position.

5. The railcar of claim 2, wherein each discharge gate of the plurality of discharge gates comprises a gate width in the longitudinal direction, and each ridge of the plurality of ridges comprises a ridge width at the widest portion of the ridge in the longitudinal direction, and the gate width is approximately equal to the ridge width.

6. The railcar of claim 1, wherein:
each gate of the plurality of gates is coupled to an adjacent gate of the plurality of gates; and
the gate actuator is operable to slide each discharge gate of the plurality of discharge gates simultaneously.

7. The railcar of claim 1, wherein the gate actuator comprises a rack and pinion.

8. The railcar of claim 7, wherein the pinion is coupled to the support frame and at least one of the discharge gates comprises the rack operably coupled to the pinion.

9. The railcar of claim 1, further comprising two hoppers, wherein:
the gate actuator is disposed between the two hoppers; and
the gate actuator slides the plurality of discharge gates towards a center of the railcar to open the plurality of discharge gates.

10. The railcar of claim 1, further comprising a low friction material disposed between a portion of the support frame and the plurality of discharge gates.

11. The railcar of claim 1, wherein the support frame comprises a pair of support members coupled to the pair of sidewalls.

12. A sliding gate assembly for a railcar, the railcar having an underframe, a pair of sidewall assemblies and at least one hopper formed between the sidewall assemblies, the sliding gate assembly comprising:
a support frame configured to extend longitudinally along the at least one hopper proximate a plurality of discharge openings in the at least one hopper;
a plurality of discharge gates slidably coupled to the support frame;
a plurality of brackets coupling each discharge gate of the plurality of discharge gates to an adjacent discharge gate; and
the plurality of discharge gates operable to slide between a closed position where the plurality of discharge gates are configured to be disposed adjacent to the plurality of discharge openings to restrict the discharge flow of lading from the at least one hopper, and an open position where the plurality of discharge gates are configured to be disposed between the plurality of discharge openings to permit the discharge flow of lading from the at least one hopper.

13. The sliding gate assembly of claim 12; wherein a longitudinal width of each discharge gate of the plurality of discharge gates and a longitudinal distance between each discharge gate of the plurality of discharge gates are configured so that a discharge gate of the plurality of discharge gates does not interfere with the discharge flow of lading from an adjacent discharge opening of the plurality of discharge openings when the plurality of discharge gates are in the open position.

14. The sliding gate assembly of claim 12, wherein a width of each discharge gate of the plurality of discharge gates in the longitudinal direction comprises a first value, and a distance between each discharge gate of the plurality of discharge gates comprises a second value, and the first value is approximately equal to the second value.

15. The sliding gate assembly of claim 12, further comprising a gate actuator operable to slide the plurality of discharge gates simultaneously.

16. The sliding gate assembly of claim 15, wherein the gate actuator comprises a rack and pinion.

17. The sliding gate assembly of claim 16, wherein the pinion is coupled to the support frame and at least one of the discharge gates comprises the rack operably coupled to the pinion.

18. The sliding gate assembly of claim 12, further comprising a low friction material disposed between a portion of the support frame and the plurality of discharge gates.

19. A railcar having an underframe, a pair of sidewall assemblies and at least one hopper formed between the sidewall assemblies, the railcar comprising:
a plurality of discharge openings, the discharge openings proximate a bottom of the at least one hopper for discharging a lading from the at least one hopper;
a plurality of ridges, each ridge of the plurality of ridges disposed between adjacent discharge openings of the plurality of discharge openings;
a center sill extending longitudinally along the center of the railcar; and
wherein the plurality of ridges are disposed below the center sill.

20. The railcar of claim 19, wherein the discharge openings extend transversely across the at least one hopper;

21. The railcar of claim 19, wherein a width of each discharge opening of the plurality of discharge openings comprises a first value, and a distance between each discharge opening of the plurality of discharge openings comprises a second value, and the first value is approximately equal to the second value.

22. A railcar having an underframe, a pair of sidewall assemblies and at least one hopper formed between the sidewall assemblies, the railcar comprising:
a plurality of discharge openings, the plurality of discharge openings proximate a bottom of the at least one hopper for discharging a lading from the at least one hopper;
a plurality of ridges, each ridge of the plurality of ridges disposed between adjacent discharge openings of the plurality of discharge openings.

23. The railcar of claim 22, wherein the discharge openings extend transversely across the at least one hopper;

24. The railcar of claim 22, wherein a width of each discharge opening of the plurality of discharge openings comprises a first value, and a distance between each discharge opening of the plurality of discharge openings comprises a second value, and the first value is approximately equal to the second value.
